(19) United States
(12) Patent Application Publication
(10) Pub. No.: US 2008/0249895 A1
(43) Pub. Date: Oct. 9, 2008

(54) Consumer preference driven negotiation apparatus, system, and method

(76) Inventor: Andrea Mariotti, Menlo Park, CA (US)

Correspondence Address: K&L GATES LLP, 535 SMITHFIELD STREET, PITTSBURGH, PA, 15222, US

(21) Appl. No.: 12/011,064

(22) Filed: Jan. 24, 2008

Related U.S. Application Data
(60) Provisional application No. 60/897,573, filed on Jan. 26, 2007.

(51) Int. Cl. G06Q 30/00

(52) U.S. Cl. 705/27

(57) ABSTRACT

An apparatus, system, and method to display information identifying an attribute such as a product preference associated with a purchased product under control of a client system. Information identifying a product attribute associated with a purchased product is displayed on a client system. The product attribute includes features that are not included in the purchase of the product. The request for the product attribute is received from a user. The request is transmitted to a host system. The host system determines whether to assign the product attribute to the user based on the request relative to other requests for the product attribute until the product attribute is no longer available for assignment.

### CROSS-REFERENCE TO RELATED APPLICATIONS

This application claims the benefit of U.S. Provisional Application No. 60/897,573, filed Jan. 26, 2007.

### BACKGROUND

The embodiments described herein may relate generally to the field of e-commerce. More specifically, the embodiments may relate to an apparatus, system, and method for managing an electronic negotiation for a preferred service, right, consideration or commodity that is other than the service, right, consideration or commodity that a ticket holder is entitled to.

Conventional electronic negotiation apparatuses, systems, and methods provide a variety of negotiating or bargaining methods for purchasing a ticket for travel or entertainment related services. In this context a ticket is a voucher to indicate that one has paid for a service, right, consideration or commodity such as admission to a theatre, movie theater, amusement park, zoo, museum, concert, or other attraction, or permission to travel on an airplane, public transit, boat trip, etc., typically because one has paid the fare. The ticket may be regarded as a proof of purchase or a commercial document showing that the holder is entitled to admission or permission to travel in accordance with a predetermined boarding and/or seating assignment. The ticket may be for an arbitrary seat (“free seating”) or for a specific one. The ticket itself, however, may not reflect the boarding and/or seating preference of the ticket holder. For example, although a ticket may entitle the holder to travel services, the ticket may not entitle the holder to their preferred boarding and/or seating assignments. An economy class passenger on an airliner, for example, may require boarding and/or seating needs that the ticket does not entitle the holder to receive. It is often difficult for such passengers to board at a preferred time and/or obtain a desired seat on a first-come, first-served basis. Although frequent flyer programs exist to address some of these issues, not everyone can benefit from or desires to participate in such frequent flyer programs and may not have a frequent flyer card. Furthermore, travelers may not get instant gratification and may not feel in control of the process. The various embodiments described herein overcome the status quo first-come, first-served service policy whereby the passengers or clients are attended to in the order that they arrived, without other biases or preferences.

In the travel industry, and more specifically in the airline industry, conventional boarding and seating assignment techniques do not allow consumers to indicate more than merely a small portion of their boarding and seating preferences. Further, conventional techniques do not provide a way to directly monetize on the opportunity to negotiate or bargain for boarding and seating preferences alone separately from the opportunity to negotiate or bargain for the purchase of a ticket to receive the right to be transported via a carrier from point A to point B.

Therefore, there may be a need for electronic negotiation techniques to enable a ticket holder to negotiate for a preferred service, right, consideration or commodity that is other than the service, right, consideration or commodity that the ticket holder is entitled to. More specifically, there may be a need for electronic negotiation techniques to enable a ticket holder to negotiate for a preferred boarding time and/or seating assignment that is other than the boarding time and/or seating assignment that the ticket holder is entitled to. The term consumer may be used herein to refer to any person that uses a product or purchases the right to use a commodity, service, right, consideration or commodity, and may be referred to herein generally as a “user.” Thus, the term consumer is intended to encompass any ticket holder, ticket purchaser, traveler, passenger or any person that purchases or holds a ticket for a right, service, consideration or commodity such as the right to travel on public or private transportation or the right to admission to an entertainment venue, and the like.

### SUMMARY

In one embodiment, a consumer preference driven displays information identifying at least one product preference associated with a purchased product under control of a client system. The information identifying a product attribute associated with a purchased product is displayed on a client system. The product attribute comprises features that are not included in the purchase of the product. The request for the product attribute is received from a user. The request is transmitted to a host system. The host system assigns the product attribute based on the request relative to other requests for the product attribute until the product attribute is no longer available for assignment.

### BRIEF DESCRIPTION OF THE DRAWINGS

FIG. 1 illustrates one embodiment of a consumer preference driven system as may be implemented in a distributed environment.

FIG. 2 illustrates one embodiment of a technology stack of software subsystems, components or modules of the distributed consumer preference driven system shown in FIG. 1.

FIG. 3 illustrates one embodiment of a user interface consumer client screen provided by a consumer client system comprising a web based client running on a browser.

FIG. 4 illustrates one embodiment of a user interface consumer client screen provided by a consumer client system comprising a web based client running on a browser.

FIG. 5 illustrates one embodiment of a printed dictionary for a visual-match authentication system comprising a plurality of symbols in the form of human understandable non-ambiguous shapes in multiple colors or in black and white.

FIG. 6 illustrates one embodiment of a Key Document.

FIG. 7 illustrates one embodiment of a Lock Document with multiple listings to form a flight roster.

FIG. 8 illustrates one embodiment of usage of symbols for visual matching between an e-ticket and a flight roster.

FIG. 9 illustrates one embodiment of a non-raster based dictionary for a symbol.

FIG. 10 illustrates one embodiment of a Key Document in the form of an e-ticket comprising a non-raster based dictionary.

FIG. 11 illustrates one embodiment of a Lock Document with multiple listings to form a flight roster and one embodiment of the usage of symbols for visual matching.

### DETAILED DESCRIPTION

Various embodiments of a consumer preferences driven system are described. The consumer preferences driven system may be directed generally to an apparatus, system, and method for managing an electronic negotiation for an attribute (e.g., a consumer preference) of a purchased product. An attribute of the purchased product may include, for example, a preferred service, right, consideration or commodity that is other than the service, right, consideration or commodity of the purchased product itself. In one embodiment, the consumer preferences driven system may be directed generally to an apparatus, system, and method for managing an electronic based negotiation for various attributes associated with a ticket. In this embodiment, the consumer driven preferences system enables a consumer holding a ticket for a service, right, consideration or commodity to conduct an electronic negotiation or to bargain for attributes of the ticket such as the right to purchase an upgrade or a preferred service, right, consideration or commodity that is other than the service, right, consideration or commodity conveyed by the ticket. Thus, after purchasing or otherwise obtaining a ticket, a consumer may employ the consumer driven preferences system to conduct an electronic negotiation for the right to purchase attributes associated with the ticket such as an upgrade or a preferred service, right, consideration or commodity than is other than the service, right, consideration or commodity conveyed by the ticket. For convenience and clarity, throughout this description, the term “product” is used to refer to a service, right, consideration or commodity sold or otherwise provided by a vendor. Thus, in this context for example, a ticket may entitle the holder to a product, wherein the product may be a service, right, consideration or commodity. In the context of travel services, for example, a consumer may purchase a ticket for the right to travel on an airliner, wherein the product comprises the right to board the airliner at a predetermined time and/or the right to sit in a predetermined seat in accordance with the rights conveyed by the ticket. Attributes of a product are features of the product other than the features originally conveyed to the consumer. For convenience and clarity the terms “negotiation” and “bargaining” may be used interchangeably throughout the description.

After a consumer purchases a right to a product, embodiments of the consumer preference driven system enables the consumer electronically negotiate for the right to purchase attributes associated with the product such as an upgrade or for a preferred configuration or arrangement of the product that is beyond the right initially purchased. Accordingly, the consumer preference driven system provides a way to directly monetize the opportunity to negotiate for attributes such as upgrades and consumer preferences alone, separately from the purchase of the original product. The opportunity to negotiate for attributes may occur prior to the completion of the transaction and before any money is exchanged.

The product may be provided or sold by a variety of vendors. In the embodiment where the product is a ticket, a vendor sells a ticket to the consumer and conveys certain rights to the ticket holder. In the provision of travel services, for example, the vendor sells the consumer a ticket entitling the consumer to a predetermined product, such as the right to travel on a vehicle, to board the vehicle at a predetermined time and/or to sit in a predetermined seat. In this context, boarding is the act of admission on a vehicle such as an airplane, ship, vessel, train, bus, truck, and the like. In another context, boarding is the act of admission to a theatre, movie theater, amusement park, zoo, museum, stadium, concert, or other attraction. In either context, a seating assignment is the seat that the ticket holder is entitled to sit in. A carrier refers to any individual or company, such as an airline, cruise or shipping line, trucking line, bus line or railroad engaged in the transportation of people or objects for profit or otherwise using a variety of transport vehicles such as: airplanes, ships, trains, trucks, buses, automobiles, and/or any other means of transportation.

The consumer preference driven system enables the holder of a product to negotiate for an attribute of the product that is other than what was originally conveyed to the consumer. In one embodiment, the consumer preference driven system enables a ticket holder to electronically negotiate for attributes associated with the ticket such as a preferred or upgraded boarding and/or seating assignment on an airplane after the ticket is purchased. These electronic negotiation techniques may be especially applicable in the travel service industry, and more specifically in the airline industry. Accordingly, for convenience and clarity, the various embodiments of the consumer preference driven system are discussed herein in the context of the travel services industry, and more specifically to the airline industry, where the consumer purchased a ticketed for the right to travel on an airplane. It should be understood, however, that the scope of the claims is not limited in this context and may be applicable to any products or industry that provides a product for which the consumer can negotiate for attributes associated with the product such as an upgrade or preferred configuration thereof. For example, the consumer preference driven system may be applicable to the entertainment and other industries.

Accordingly, embodiments of the consumer preference driven system described herein may provide consumers with the option to electronically negotiate exclusively for any attributes associated with a product and in one embodiment provides consumers with the option to negotiate exclusively for boarding and/or seating preferences alone (e.g., apart from negotiating for the purchase of a ticket). This exclusive attribute negotiating option may generate new revenue streams for these industries. It should be noted that any of the embodiments discussed herein may be implemented in a manner that does not affect existing best practices and consumer habits.

One embodiment of a consumer preference driven system may provide a traveler (e.g., a form of consumer of travel services or passenger) with an opportunity to purchase attributes such as a boarding time and seating assignment that is different from or other than the boarding time and the seating assignment indicated on the ticket. The traveler may select a different seating assignment based on a seat map of the vehicle or venue, a set of inherent features thereof or any other predetermined selection criteria.

The consumer preference driven system may provide the consumer with multiple purchasing methodologies. One purchasing methodology may be referred to herein as an “a la carte” attribute (e.g., seat) selection method (herein, the term “a la carte” may be used to refer to a menu system or process having individual items listed with separate prices and/or selecting these individually listed items on the menu system). In accordance with the first purchasing methodology, the consumer may be offered the opportunity (e.g., chance) to select a personalized set of preferences or attributes. For a purchased ticket, for example, the first purchasing methodology may provide the consumer with the opportunity (e.g., chance) to select a personalized set of preferences for a seat location comprising: an aisle seat, a window seat, a seat near a lavatory, a seat away from the lavatory, a seat away from minors, a front seat, a back seat near a ramp, a seat with power plugs for electronic devices, a seat with Internet access, and the like.

Another purchasing methodology may be referred to herein as a bidding seat selection method. In accordance therewith, the consumer may first be presented with various attributes associated with the product and may request a bid for the desired attributes. In the embodiment where the purchased product is a ticket, the consumer may first be presented with various attributes associated with the ticket such as a seating layout or chart. The consumer may select a number of specific seat locations, for example, three. The consumer may be asked to indicate an amount that they would be willing to pay for each chosen seat. Conversely, the consumer may agree to simply pay a flat fee regardless of which of the chosen seats they may ultimately be awarded.

In one embodiment, the consumer preference driven system may guarantee that one of the selected attributes such as seat assignments will in fact be assigned to the consumer. The system may notify the consumer once the seating assignments are finalized and the financial transaction is committed. It should be noted that the number of purchasing choices available to the consumer may be flexible (e.g., modifiable or adaptable) and may depend on the prevailing conditions at the time the selection is made. Accordingly, in one embodiment, software instructions or code may be executed by a processor to provide the consumer with a correct minimum number of choices they must make in order to guarantee such seat assignment. Of course other purchasing methodologies may be employed without limitation. Throughout this description, any of these purchasing methodologies may be referred to as consumer preferred purchasing methodologies of the consumer preference driven system. The above examples with respect to seating assignments also are applicable to the boarding preferences.

It should be noted that some of the embodiments of the consumer preference driven system described herein may be directed to negotiating for boarding and/or seating assignment preferences on an airplane. Embodiments of the consumer preference driven system may provide passengers an opportunity to negotiate for access to specific seat locations within the layout of the airplane to accommodate their personal preferences in exchange for a negotiated payment amount. Various other embodiments of the consumer preference driven system may provide passengers an opportunity to negotiate for boarding services such as paying for the right to board or be admitted on the airplane at a preferred time other than the time indicated on the ticket in exchange for a negotiated payment amount. For example, an economy passenger would have an opportunity to negotiate to pay a fee to board at the same time as business class or first class passengers. A benefit to the economy passenger would first choice to the overhead storage bins, for example.

In various embodiments, the consumer preference driven system, apparatus, and/or method may be illustrated and described as comprising several separate functional elements, components, modules, and/or blocks. Although certain elements, components, modules, and/or blocks may be described by way of example, it can be appreciated that additional or fewer elements, components, modules, and/or blocks may be employed without limitation to the scope of the embodiments. Further, although the various embodiments may be described in terms of elements, components, modules, and/or blocks to facilitate description, such elements, components, modules, and/or blocks may be implemented by one or more hardware components (e.g., processors, DSPs, PLDs, ASICs, circuits, registers), software components (e.g., programs, subroutines, logic), and/or combination thereof.

Various embodiments of the consumer preference driven system may comprise one or more components that may be implemented as one or more application software modules. In one embodiment, a software module may comprise an optimization algorithm. The optimization algorithm provides an accurate minimum number of choices that may be required by the consumer to guarantee awarding at least one preference to the consumer. In addition, the optimization algorithm provides an actual final assignment or delivery of the preferred commodity and/or service selected by all consumers that employed the consumer preference driven system. For example, in the context of an airline passenger, the optimization algorithm may provide an accurate minimum number of choices of seats required to guarantee the assignment of one of the seats and to provide an actual final boarding preference and/or seating assignment for all passengers using the consumer preference driven system for a particular flight. In another embodiment, the software module may comprise one or more communication modules to enable the optimization algorithm to communicate with other modules over a network. Additionally, the communication module may enable web clients to access a database (as described in more detail below) to set up, store, and edit their choices and financial transactions.

Example simulation data indicates that one embodiment of the consumer preference driven system may achieve about a 92% success rate using a predetermined minimum number of product preferences. Although theoretically the consumer preference driven system may achieve a 100% success rate by increasing the predetermined minimum number value, for practical reasons, a simulated assignment may be executed on demand to determine if a particular consumer needs to provide more product preferences in order to guarantee an award. The embodiments are not limited in this context.

In one embodiment, the consumer preference driven system may comprise a database. The database may be provided to partially replicate the necessary information associated with a consumer preference. In addition, the database may store the choices, bids, and other financial information for each consumer for each product that may serve as the basis of a bargain. For example, in the context of the airline industry, the database may partially replicate and store flight and layout information for a particular flight and airplane. In addition, this database may store the choices, bids, and other financial information for each passenger for each flight.

In yet another embodiment, the consumer preference driven system may comprise a web client accessible via a wired and/or wireless wide area network (WAN) such as the internet, for example, via a user (e.g., the consumer) single sign-on paradigm (e.g., a transparent sign on driven by an online service of the vendor) or a user initiated log-in. The web client may allow the user to access either the “a la carte” or bidding seat selection methods in accordance with their selected preferences. The web client also may perform the “a la carte” or bidding selection operations described above to collect financial information relative to the transaction.

In one embodiment, the consumer preference driven system may comprise an administration cockpit component. This component may be or may comprise a web based interface to allow users with system administration privileges to monitor the state of the system and set working parameters such as when to finalize seating assignments and transmit the information to the airline system and possibly directly notify travelers.

The various embodiments described herein provide several advantages and may be implemented in accordance with various techniques. For example in one embodiment, the system may be a hosted service where the vendor (e.g., an airline) pays a third party to provide the consumer preferred services as described herein. The third party may offer the vendor the lowest possible cost with the agreement that the third party retains a percentage of the revenue paid by the consumer for each transaction. In other embodiments, the third party may provide a turn-key module comprising a pre-installed software application. Several of these turn-key modules may be provided to account for increased demand of the commodity and/or service. Accordingly, the third party may generate revenue on a per transaction basis plus a service fee for support and maintenance, for example.

Accordingly, the embodiments of the consumer preferences driven system described herein may allow a consumer to negotiate in accordance with their preferences. In the context of an airliner, a consumer may be allowed to negotiate in accordance with their particular seating preference during a flight. In addition, the various embodiments may allow a consumer to negotiate in accordance with their boarding preferences for a flight, e.g., when to board the airplane. Those skilled in the art will appreciate that the scope of the embodiments discussed herein may be extended to other consumer preferences without loss of generality and therefore the embodiments are not limited in this context.

In one embodiment, the system may comprise a module to assign the consumer preferences. The module may construct a data structure to represent the set of demand/offers and how to process such data structure using an augmented version of an Edmonds-Karp algorithm, for example. Such a module may provide a non-trivial technological advantage to conventional implementations and may provide optimal or sub-optimal results that are better when measured in terms of speed, asymptotical complexity, and accuracy as compared to conventional systems.

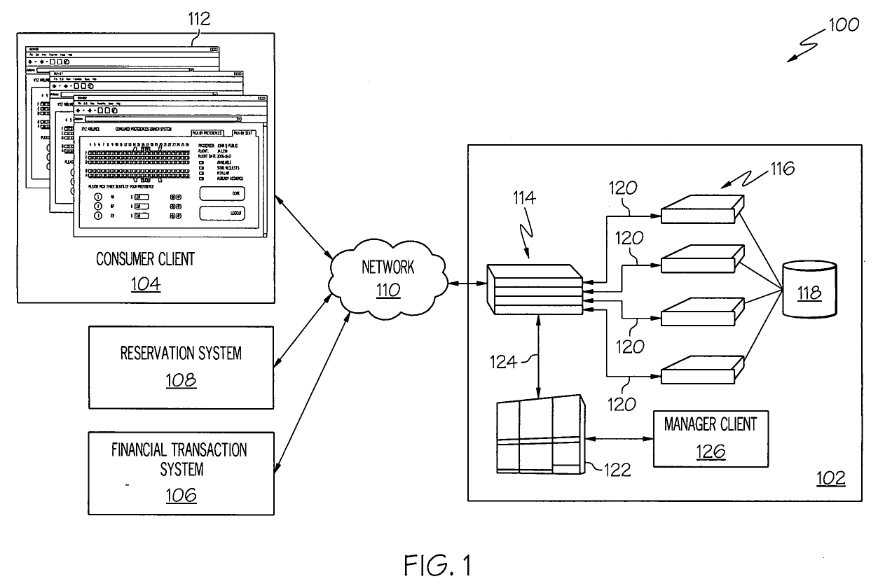

FIG. 1 illustrates one embodiment of a consumer preference driven system 100 as may be implemented in a distributed environment. The system 100 may comprise a consumer preference driven host system 102 to communicate with one or more consumer client systems 104, financial systems 106, and/or reservation systems 108 over a network 110. The network 110 may be a wired and/or wireless geographically dispersed telecommunications network such as a WAN and/or the internet, or a local area network (LAN), or any other wired or wireless telecommunications network that supports communications between multiple computers. These computers may communicate with web servers using a variety if web browsers.

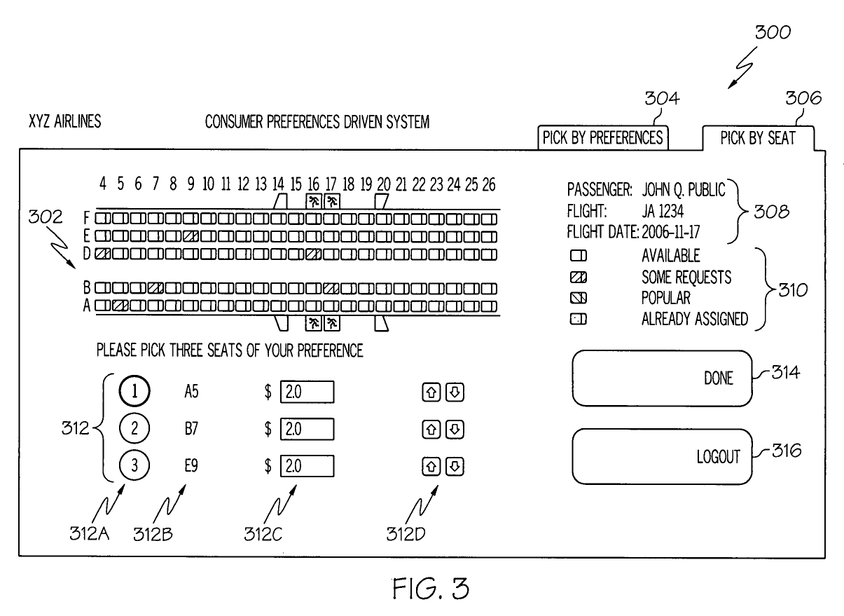

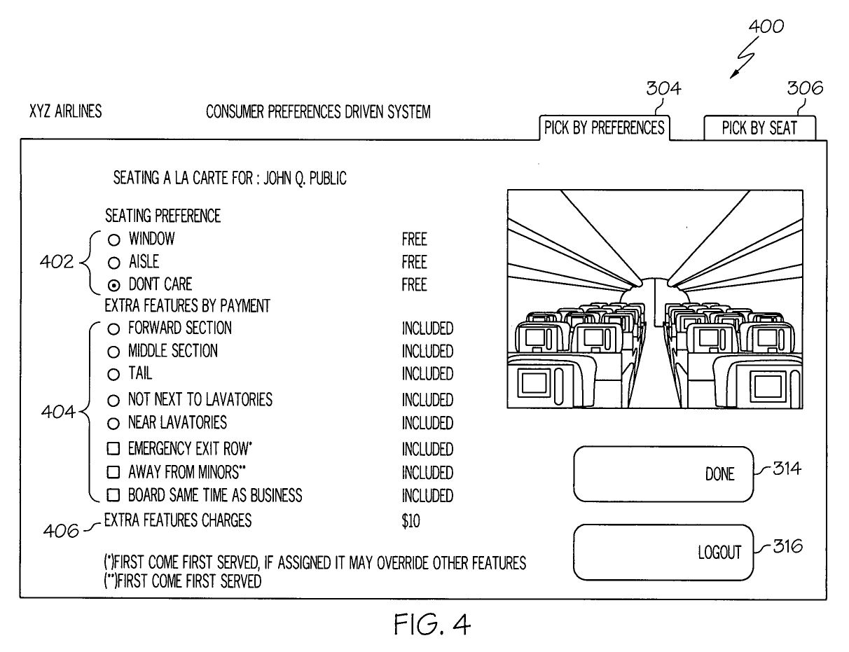

In one embodiment, the consumer client system 104 may comprise a web based client running on a browser and may provide one or more user interfaces shown in the form of consumer client screens 112. The type of browser and/or the underlying platform of the consumer client system 104 used by the consumer to access the consumer preference driven host system 102 is not limited to any specific type and should not be limited in this context. The consumer client 104 allows the consumer to navigate through the consumer client screens 112 and other user interfaces so that the consumer can express their preferences. The consumer client 104 also may be employed to collect financial information for billing purposes. Examples of the consumer client screens 112 are discussed in more detail below with reference to FIGS. 3 and 4. The embodiments, however, are not limited in this context.

In one embodiment, the consumer preference driven host system 102 may comprise one or more web servers 114 to provide an interface to the consumer client system 104, the financial transaction system 106, and/or the reservation system 108 over the network 110. The web servers 114 may be scalable and load balanced. The web servers 114 may be coupled to one or more application servers 116 over a network 120, for example. The application servers 116 may be coupled to or may comprise one or more databases 118 to store consumer preference transactional data or any other information related to the consumer preference driven system 100. The consumer preference transactional data may comprise consumer information and preferences data, ticketing information including external system reference identification, product related information including system reference identifications, and/or physical layout information associated with the product. An enterprise resource planning (ERP) system 122 may be coupled to the web servers 114, the application servers 116, and/or the databases 118 over a network 124. The ERP system 122 may integrate (or attempt to integrate) all data and processes associated with the distributed consumer preference driven system 100 and/or the host system 102 into a unified system. In one embodiment, the ERP system 122 may comprise or use multiple components of computer software and hardware and a unified database to store data for the various system modules to achieve the integration.

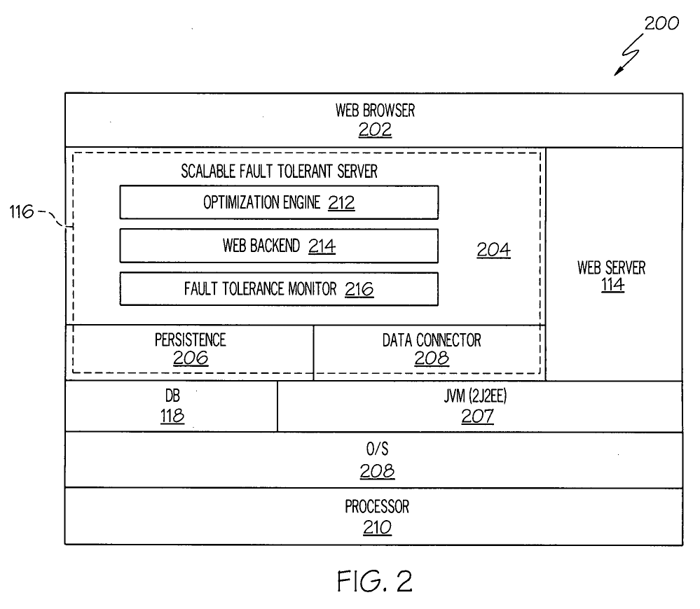

A manager client 126 component or module enables a system administrator to manage settings and transaction classes across the system 100. The settings that determine the chronology of events for a certain class of transactions may be referred to as a transaction class setting. In the airline industry embodiment, for example, a transaction class may be a flight number for an airline. Therefore, for each flight number the system administrator can set the time intervals available to consumers using the consumer preference driven system 100 and at the time intervals the system 100 closes access thereto and determines the boarding and seating assignments. For example, a flight that repeats every Wednesday at 10 am may be set to have the consumer preference driven system 100 available up to three months prior to the date of the flight and it could be set to close and finalize boarding and seating assignments 48 hours prior to departure. The manager client 126 may be implemented as a web based application and may be similar to the consumer client system 104 in term of technology and connectivity. Those skilled in the art will appreciate that the information technology (IT) department of an airline may decide whether to make the manager client 126 reachable outside the corporate firewall or via a virtual private network (VPN), WAN (e.g., the network 110), and so on. The application servers 116 and the application modules executed thereby are described in more detail below with reference to FIG. 2.

In one embodiment, the consumer client system 104 comprises a graphical user interface 112 to display information identifying a product attribute associated with a purchased product. The product attribute comprises features that are not included in the purchase of the product. The consumer client system 104 receives a request from a user for the product attribute. The request is transmitted to the consumer preference driven host system 102. The consumer preference driven host system 102 assigns the product attribute to the user based on the request relative to other requests for the product attribute until the product attribute is no longer available for assignment. The assignment or denial thereof is communicated to the user via the graphical user interface 112. The request may include any one of a bid price for the attribute, a single user preference request for the attribute, and a multi-user preference request for the attribute. The product attribute may be assigned in a manner that satisfies a maximum number of users that submit a number of requests for the product attribute. The product attribute may be assigned to satisfy the maximum number of users based on the request for the product attribute or the number of requests for the product attribute. The request for the product attribute is relative to a base price of the product and does not impact the base price of the product.

The assignment of the product attributes of limited availability may occur over a predetermined time frame. A current request for the product attribute may be assigned if the current request can be satisfied based on all previous requests for the product attribute and the current request for the product attribute. Otherwise, the current request for the product attribute may be denied if the current request cannot be satisfied based on all previous requests for the product attribute. The consumer client system 104 may receive alternative product attributes to the user if the current request for the product attribute is denied from the consumer preference driven host system 102 and provides these alternatives to the user via the graphical user interface 112. The graphical user interface 112 displays a predetermined minimum number of product attributes to guarantee at least one choice to the user. In one embodiment, the purchased product is a travel ticket and the product attribute includes any one of a boarding preference and a seating preference associated with the purchased ticket. The boarding preference and the seating preference attributes are not included in the purchased travel ticket.

The consumer preference driven host system 102 transmits information identifying a product attribute associated with the purchased product to the consumer client system 104. The product attribute comprises features that are not included in the purchased product. The consumer preference driven host system 102 receives a request from the consumer client system 104 for the product attribute. The consumer preference driven host system 102 assigns the product attribute to the user based on the request relative to other requests for the product attribute until the product attribute is no longer available for assignment. The application servers 116 of the consumer preference driven host system 102 determine a minimum number of product attributes to guarantee at least one choice to the user. The application servers 116 comprise an optimization engine 212 (FIG. 2) to determine the minimum number of product attributes in accordance with an optimization process. The minimum number of product attributes is then transmitted to the client system 104 for display via the graphical user interface 112. As previously discussed, the request includes any one of a bid price for the attribute, a single user preference request for the attribute, and a multi-user preference request for the attribute.

The optimization engine 212 assigns the product attributes to satisfy a maximum number of users that submit a number of requests for the product attribute. The product attributes may be assigned in a manner that satisfies the maximum number of users based on the request for the product attribute or the number of requests for the product attribute and relative to a base price of the product without impacting the base price of the product. Product attributes of limited availability may be assigned over a predetermined time frame. For example, the optimization engine 212 may determine to assign a current request for a product attribute only if the current request can be satisfied based on all previous requests for the product attribute and the current request for the product attribute. Otherwise, the optimization engine 212 may deny the current request for the product attribute and may transmit alternative product attributes available to the user to the consumer client system 104. The optimization engine 212 may determine a predetermined minimum number of product attributes to guarantee at least one choice to the user and transmits this information to the consumer client system 104. In one embodiment, the optimization engine 212 comprises instructions that when executed by a processor determine a maximum flow from a source “s” to a sink “t” to determine an optimal assignment of product attributes according to user preferences. These algorithms are described hereinbelow in more detail. The consumer preference driven host system 102 transmits a predetermined minimum number of product attributes to guarantee at least one choice to the user to the consumer client system 104 via the web server 114.

FIG. 2 illustrates one embodiment of a technology stack 200 of software subsystems, components or modules of the distributed consumer preference driven system 100. The stack 200 may comprise the web server 114, the application server 116, and the databases 118 to deliver the functionality to implement the distributed consumer preference driven system 100. The application server 116 may comprise consumer preference driven system components. The application server 116 may comprise a scalable fault tolerant server (SFS) module 204, a persistence layer 206, and a data connector 208. A web browser 202 executing instructions (e.g., running) on the consumer client system 104 may be used to interface with the web server 114 and access the application server 116. The application server 116 may reside anywhere in the distributed system 100 and may interface with the database 118 and a java virtual machine (JVM) 207 to interpret and execute Java bytecode. The underlying operating system 208 may be the Windows® operating system by the Microsoft® Corporation or may be a Linux based operating system. The underlying core platform processor 210 may comprise a 32-bit multi-core processor platform. The embodiments, however, are not limited in this context.

In one embodiment, the application server 116 may comprise the SFS module 204. The SFS module 204 may be a distributed fault-tolerant application that provides the functionality to implement a web back-end 214 to the consumer client 104 and to the manager client 126 (FIG. 1), an optimization engine 212 for assignment determination, a data connector 208 and a fault-tolerance monitor 216. The SFS module 204 may be adapted and configured to implement the logic necessary to communicate information with the reservation systems 108 and the financial transaction systems 106. In addition, the optimization engine 212 may be employed to determine the best possible assignments (“optimal assignment”) of consumer preferences (e.g., boarding, seating) given the requests from the consumers and the availability at the time the requests are made. The SFS module 204 also may comprise a notification engine to provide email notification to users in accordance with actions and events that are taking place in the distributed consumer preference driven system 100. Actions and events may comprise, for example, receiving a final assignment in accordance with the consumer preferences. The embodiments, however, are not limited in this context.

In one embodiment, the optimization engine 212 may comprise a software module comprising executable instructions to represent available preferences and requests placed by users in terms of a graph and to reduce the graph to a mapping of each distinct preference with a distinct request using a pruning algorithm. It will be appreciated y those skilled in the art that the term “pruning: in mathematics and informatics describes a method of enumeration, which allows cutting parts of a decision tree. The pruned parts of the tree are no longer considered because the algorithm knows based on already collected data (e.g., through sampling) that the sub-trees do not contain the searched object. Thus, the decision tree may be simplified by removing some decisions.

In one embodiment, the optimization engine 212 may comprise a software module comprising executable instructions to implement an algorithm derived from the Ford-Fulkerson algorithm to determine an optimal assignment of consumer preferences. Those skilled in the art will appreciate that the Ford-Fulkerson algorithm may be employed to determine the maximum flow from a source “s” to a sink “t.” Accordingly, for a graph G(V,E) having a capacity c(u,v) and a flow f(u,v)=0 for the edge from u to v, after each step of the algorithm the following relationships are maintained:

$$\begin{matrix}f ( u , v ) \leq c ( u , v ) & ( 1 ) \\ f ( u , v ) = - f ( v , u ) & ( 2 ) \\ {\sum }_{v} f ( u , v ) = 0 & ( 3 )\end{matrix}$$

Therefore, the flow f between u and v does not exceed the capacity and the net flow is maintained. The sum of the flows for all nodes except s and t is zero. The amount of flow into a node equals the amount of flow out of the node.

In other words, the flow through a network may be considered a legal flow after each round in the algorithm. A residual network Gf(V,Ef) may be defined as a network having a network capacity cf(u,i)=c(u,v)−j(u,v) and no flow. It is not certain that E=Ef, because sending a flow on u,v might close u,v (it is saturated), but it may open a new edge v,i in the residual network Gf. Therefore, for inputs into graph G having a flow capacity c, a source node s, and a sink node t, the output flow f such that f is maximal from s to t may be expressed as:

f(u,v)←0 (4)

for all edges u,v. While there exists a path from s to t in Gf, the following steps are executed:
(a) Find a path u₁, u₂, . . . , uₖ (5) where u₁=s and uₖ=t, such that cf(uᵢ,uᵢ+1)>0;
(b) Find m=min(cf(uᵢ,uᵢ+1));
(c) f(uᵢ,uᵢ₊₁)←f(uᵢ,uᵢ₊₁)+m (6) (send flow along the path); and
(d) f(uᵢ₊₁,uᵢ)←f(uᵢ₊₁,uᵢ)−m (7) (the flow might be “returned” later).
   The path may be found with a breadth-first search or a depth-first search in Gf(V,Ef), for example. If the former is used, the algorithm may be referred to as an Edmonds-Karp algorithm.

In one embodiment, the optimization engine 212 may be based on the Edmonds-Karp algorithm implementation of the Ford-Fulkerson algorithm to determine an optimal assignment of consumer preferences. In this embodiment, the Ford-Fulkerson algorithm is augmented such that the input to the Edmonds-Karp algorithm comprises an augmented bipartite graph. An augmented bipartite graph may be defined as a bipartite graph where a vector t of all consumers that placed a request via the consumer preference driven system 100 is provided on the left side and a vector s of all possible options available to the consumer (e.g., “seats” in the case of an airline) is provided on the right side. Each directed edge from a member of t to a member of s represents a preferred assignment (e.g., preferred seat assignment). Further, |t|<=|s| and there are at most |s|² possible edges that can be assigned prior to running the optimization engine 212 between the two vectors (t and s). The bipartite graph is augmented with two more nodes called t and s, where t represents the source of the resulting directed graph whereas s represents the sink. Further, t is connected to each element in t with a single directed edge of constant capacity (i.e., capacity=1) and each element in s is connected similarly to s via a single directed edge with same constant capacity. Such augmented bipartite graph is generated prior to running the optimization engine 212 and those skilled in the art will appreciate that the resulting structure is a directed acyclic graph (DAG), for example.

Prior to augmentation the capacity of each edge in the bipartite graph may be set to the cost function:

cᵢⱼ(r,b) for all i in t and for all j in s (8)

where r is the preference ranking of the consumer preference (e.g., boarding or seating assignment), which may be set to 1 by default; b is the bid amount, that is, the amount of monetary compensation that the consumer has agreed to pay for this preference; and where cᵢⱼ (r,b) is directly proportional to r and inversely proportional to b. The outputted DAG of the Edmonds-Karp algorithm is then reduced back to a bipartite graph that represents the optimal consumer preference assignments. In addition to the above, the Edmonds-Karp algorithm may be further modified to check the cardinality of the output DAG to ensure that a minimum threshold is reached. If it is not, the optimization engine 212 may be executed again and this may be repeated a pre-defined number of times until either the minimum cardinality threshold is passed or the pre-defined number of repetitions occurs. In the latter, the optimization engine 212 may be designed to take the best sub-optimal solution out of the repetitions. Those skilled in the art will appreciate that the number of isolated nodes in the DAG may be directly proportional to the number of consumer preferences that are not satisfied (e.g., where a consumer request for a preferred seat assignment cannot be met). The goal is to keep this number as close as possible to 0 (zero). Those skilled in the art should recognize that the DAG can easily be altered to implement the group functionality. The group functionality herein refers to the possibility that two or more consumers choose product preferences that are strictly coupled. In the example of the airline industry two or more consumer may decide to provide several product preference sets with the goal to have one of such set of product preferences to be awarded to all of the consumers in that group at the same time. Those skilled in the art will further recognize that in one embodiment this can be achieved by altering the arc or arcs that connect the bipartite graph to the sink.

It should be appreciated that the globally maximized awarding process described herein may be executed not necessarily to maximize profits, but rather to maximize consumer satisfaction. For example, the globally maximized awarding process described herein may be executed to maximize the number of satisfied consumers that give repeat business in return.

The data connector 208 component enables each instance of the SFS module 204 to perform discovery of service and detection of other instances. Further, it enables the fault-tolerance monitor 216 to perform the necessary queries to other instances of the SFS module 204 to estimate the state of the whole distributed consumer preference driven system 100. In addition, the data connector 208 provides the means to import and export data in the database 118. The data may be exchanged in extensible markup language (XML) format. Those skilled in the art will appreciate that the document type definition (DTD) may be obtained by mapping the database 118 schema.

The fault-tolerance monitor 216 component relies on the persistence layer 206 and the data connector 208 to establish the state of the distributed consumer preference driven system 100. Multiple instances of the SFS module 204 may be deployed at the same location for the same consumer client 104 throughout the distributed consumer preference driven system 100. The fault-tolerance monitor 216 may connect with the database 118 to look for inconsistent records in each table. An inconsistent record may be defined as a record that is left on the database 118 when a process is interrupted by a fault in the SFS module 204. Those skilled in the art will appreciate that this process may be completed by enforcing atomic operations, using status flags on each record and logging which instance of the SFS module 204 is handling which record.

The persistence layer 206 is a database component that stores all the transactional data related to the distributed consumer preference driven system 100 plus it stores metadata that may be relative to a specific implementation. For example, in the airline industry embodiment, the database 118 may store, for example:
(a) Traveler information and preferences;
(b) Ticket information including external system reference identifications;
(c) Flight information including external system reference identifications; and
(d) Aircraft layout information.

The database 118 may be made available to the other components via the persistence layer 206. The persistence layer 206 may comprise, for example, a set of application programming interfaces (API) that enables communications with the database 118 without having any knowledge of the database vendor or other characteristic. This feature enables the implementation of the database 118 to be swapped without having to make any changes to all the components of the distributed consumer preference driven system 100 except for the persistence layer 206. For example, in one implementation, a POSTGRES based database implementation may be swapped with an ORACLE 10G based implementation without affecting any other component.

FIG. 3 illustrates one embodiment of a user interface consumer client screen 300 provided by the consumer client system 104 comprising a web based client running on a browser. As previously discussed the consumer client system 104 may provide one or more user interfaces shown in the form of the consumer client screen 300. In the illustrated embodiment, the consumer client screen 300 is directed to the airline industry and shows a seat map 302 for an airplane of the “XYZ Airlines,” for example. The consumer may select preferences by selecting a “pick by preferences” tab 304 or may select by seat by selecting a “pick by seat” tab 306. The consumer client screen 300 provides the name of the passenger, the flight, and flight date information 308. The consumer client screen 300 also provides a legend 310 that describes available seats, which seats have some requests from other consumers, which seats are popular, and which seats are already assigned. In one embodiment, the consumer may select up to three seats 312 of their preference in a portion of the screen 300. The consumer may indicate an order of preference 312a for each of the preferred selected seats 312b. The consumer may select the amount 312c they are bidding for the preferred seat selections using the up/down buttons 312d. When the consumer has completed the preferences selection process they may press the “Done” button 314. Otherwise, the consumer may logout of the screen 300 by pressing the “Logout” button 316. The embodiments are not limited in this context.

FIG. 4 illustrates one embodiment of a user interface consumer client screen 400 provided by the consumer client system 104 comprising a web based client running on a browser. As previously discussed the consumer client system 104 may provide one or more user interfaces shown in the form of the consumer client screen 400. In the illustrated embodiment, the consumer client screen 400 is directed to the airline industry for the “XYZ Airlines.” As previously discussed, the consumer may select preferences by selecting a “pick by preferences” tab 304 or may select by seat by selecting a “pick by seat” tab 306. The consumer client screen 400 provides preferences for a named passenger. The consumer client screen 400 shows a seating preferences 402 portion, an extra feature by payment 404 portion, and an extra features charge 406 portion for an airplane of the “XYZ Airlines” airline, for example. The seating preferences 402 provides multiple choices including “Window,” “Aisle,” and “Don't Care,” for example. In one embodiment, the seating preferences 402 may be offered for free. When the consumer has completed the preferences selection process they press “Done” button 314. Otherwise, the consumer may logout of the screen 300 by pressing the “Logout” button 316. The embodiments are not limited in this context.

In one embodiment, the distributed consumer preference driven system 100 may be configured to interface with a printed visual-match authentication system. Various embodiments of the printed visual-match authentication system may be directed to a visual matching by a human for the purpose of document identification. For example, two documents may be printed at separate locations and at separate times. Each document contains a visual tag printed on one or more pages of each of the documents. The tag is an encoded representation of a unique identifier. The same tag may be printed on both documents one or more times. A list of authenticating tags may be shown to ease the recognition of multiple documents. When the two documents are brought near each other and juxtaposed, any human will be able to perform a simple visual match of the tags on each document and hence validating that the two documents contain the same encoded unique identification.

In various embodiments, the printed visual-match authentication system may employ human understandable tags and relies on human visual matching. In one embodiment, the printed visual-match authentication system tags may be language and culture independent. In one embodiment, the printed visual-match authentication system tags may be printed by any raster capable printer (most consumer printers). In one embodiment, the printed visual-match authentication system tags may be modified so that they can be printed by dot-matrix text-only capable printers.

For convenience and clarity, definitions of several elements of the following embodiments are provided. In the description that follows, two separate classes of documents and an encoded representation of unique identifiers are referenced. These elements may be defined as follows:

A “Document” is any collection of sheets of one or more sheets of paper.

A “Key Document” is a document with an “Autograph” (defined below) tag printed on one or more of its pages.

A “Lock Document” is a document containing one or a list of distinct Autograph tags printed on one or more of its pages. Multiple Key Documents may be authorized using one Lock Document if the occasion calls for it.

“Autograph” is a tag comprised of human understandable glyphs from an agreed upon dictionary and arranged in a specific sequence. For example, “ABBD” is one example of an Autograph based on the dictionary of the glyphs “A,” “B,” and “D.” In this case the tag has four graphs. In general, an Autograph tag may comprise any number of graphs arranged in a sequence each from the same dictionary.

In one embodiment, the printed visual-match authentication system comprises generating an Autograph tag from a predefined dictionary of a predetermined size with a predefined number of graphs in each tag. For example, in an Autograph tag from a predefined dictionary of size 22 there are 22 distinct graphs in the dictionary with a predefined number of graphs in each tag. For example, there may be three (3) graphs in teach tag. Therefore, with this parameter (size of dictionary=22 and the number of graphs=3 per Autograph) the possible combinations may be determined in accordance with the following formula:

(Size of dictionary)×(size of dictionary)×(size of dictionary) (9)

Namely: 22×22×22=10648

In other words, for these set of parameters 10648 distinct Autograph tags may be generated.

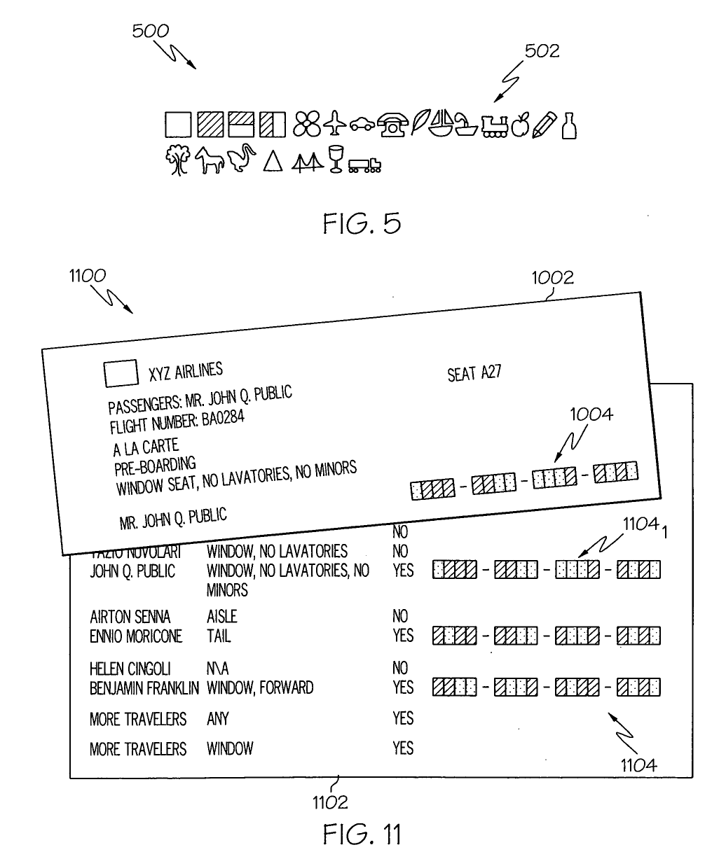

FIG. 5 illustrates one embodiment of a printed dictionary 500 for a visual-match authentication system comprising a plurality of symbols 502 (Autographs 502 hereinafter) in the form of human understandable non-ambiguous shapes in multiple colors, such as black and white, for example.

A software application may provide means to properly store the dictionary 500 and upon request, generate a full set of all possible Autographs 502 for the system 500 for a predetermined number of graphs per Autograph 502. Such set may be used as cache to provide, at random, one of the instances in the set once a request is made to issue a tag. Those skilled in the art will appreciate that this example may be employed in applications, such as the consumer preferences driven system 100 discussed above with reference to FIGS. 1-4, for example, where the number of tags required is several orders of magnitude smaller than the possible number of combinations. In the consumer preferences driven system 100 airline industry embodiment, for example, it may be necessary to issue, at most, one tag per passenger per flight so the required number of tags should not exceed a few hundred for a specific flight. An example of a Key Document will help clarify the concept. For convenience and clarity, the following description will continue to use the example of using the Autographs 502 as an authentication mechanism for the consumer preferences driven system 100 airline industry embodiment. The embodiments of the printed visual-match authentication system, however, are not limited in this context.

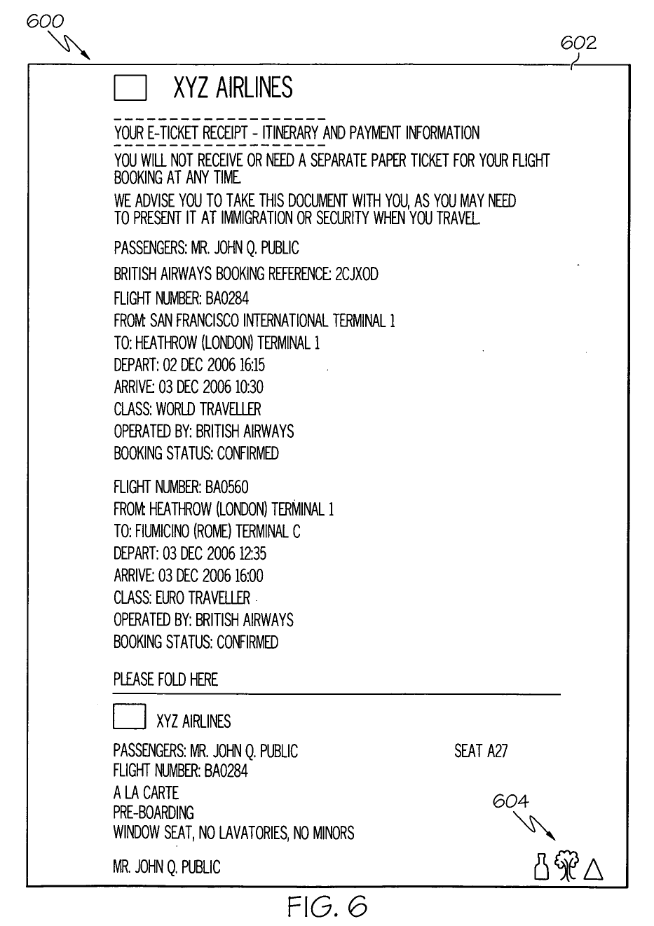

FIG. 6 illustrates one embodiment of a Key Document 600. In the illustrated embodiment, the Key Document 600 is an e-ticket 602 comprising a unique Autograph 604. In this example the Autograph 604 may be added to the e-ticket 602 when the consumer (e.g., passenger, traveler, etc.) prints the e-ticket 602 at home. At the same time the Autograph 604 for that consumer is stored into a Lock Document that is later printed by a ground crew. Therefore, the consumer may show the e-ticket 602 to the ground crew. Folding the e-ticket 602 in a tri-fold fashion much the same way it is currently done, for example, may bring the Autograph 604 in plain view for visual matching by a human (e.g., the ground crew). The ground crew then can simply look up the consumer on the flight roster that now is also a Lock Document because it contains the Autograph 604 next to the name of the passengers, where applicable.

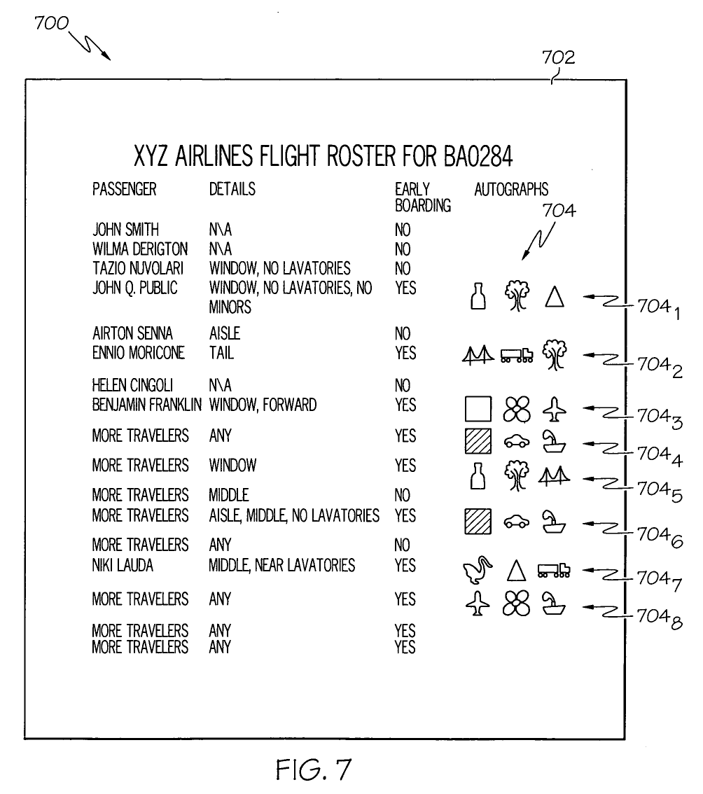

FIG. 7 illustrates one embodiment of a Lock Document 700 with multiple listings to form a flight roster 702. Next to each listing, the flight roster 702 comprises unique Autographs 704. In the illustrated embodiment, the flight roster 702 comprises multiple Autographs 704₁₋₈, one for each passenger or traveler.

FIG. 8 illustrates one embodiment of usage of the Autographs 604, 704 for visual matching between the e-ticket 602 and the flight roster 702. As shown, a glance to the flight roster 702 and the e-ticket 602 or boarding pass will suffice to visually recognize and match the two instances of the same Autographs, namely the Autograph 604 on the e-ticket 602 and the Autograph 704, on the roster 702. For example, the Autograph 604 on the e-ticket 602 matches the Autographs 704, on the flight roster 702. If there are no matches, a problem is immediately detected and the ground crew can pull that passenger or traveler aside to resolve the issue without affecting the rest of the ground operation and the speed at which they proceed.

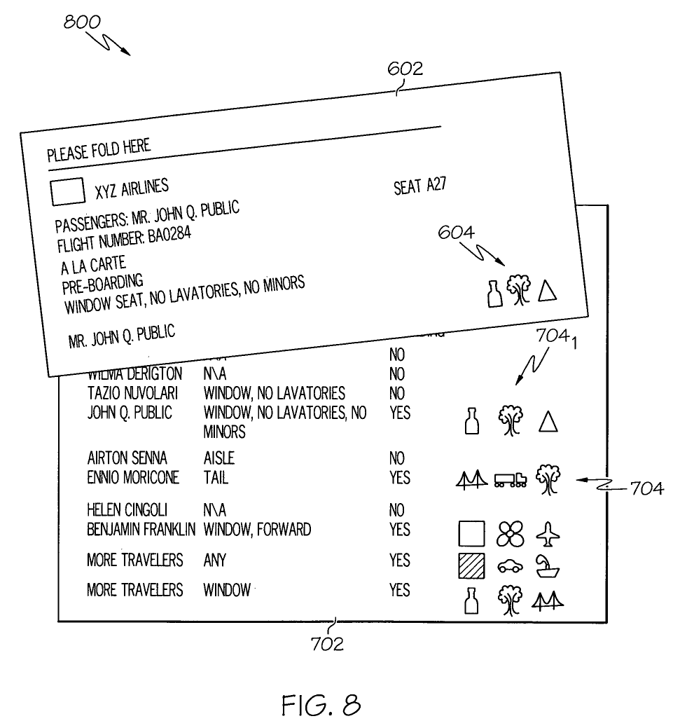

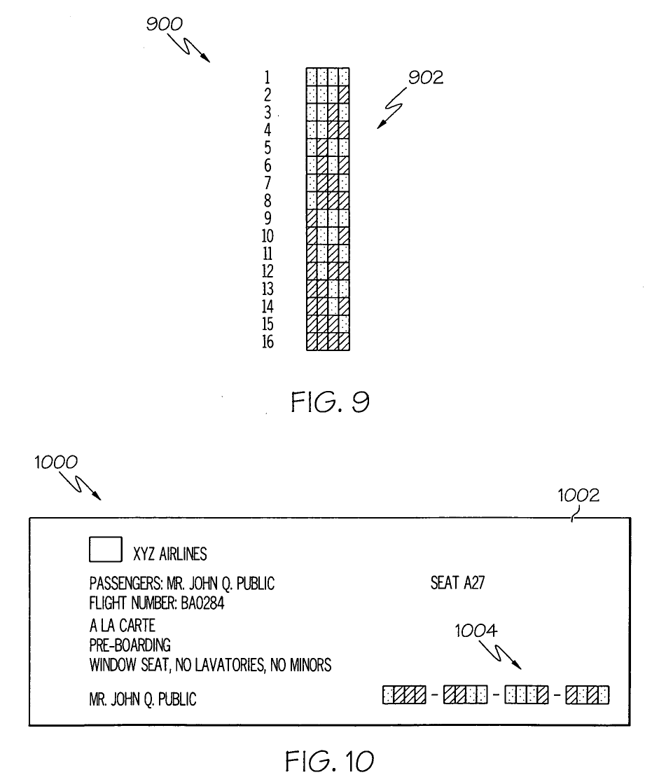

FIG. 9 illustrates one embodiment of a non-raster based dictionary 900 for an Autograph 902. The Autograph dictionary may be obtained using extended ASCII characters 176 and 178, that is [symbol] and [symbol] . In the illustrated embodiment, 16 different symbols may be mapped to form the Autographs 902 based on the non-raster dictionary 900.

FIG. 10 illustrates one embodiment of a Key Document 1000 in the form of an e-ticket 1002 comprising the non-raster based dictionary 900 to generate a three graphs based Autographs 1004 for a total of 16×16×16=4096 possible unique tags.

FIG. 11 illustrates one embodiment of a Lock Document 1100 with multiple listings to form a flight roster 1102 and one embodiment of the usage of symbols for visual matching. Next to each listing, the flight roster 1102 comprises unique Autographs 1104. In the illustrated embodiment, the flight roster 1102 comprises multiple Autographs 1104, one for each passenger or traveler. The illustrated embodiment shows one example of visually matching the Autographs 1004, 1104 between the e-ticket 1002 and the flight roster 1102. As shown, a glance to the flight roster 1102 and the e-ticket 1002 or boarding pass will suffice to visually recognize and match the two instances of the same Autographs, namely the Autograph 1004 on the e-ticket 1002 and the Autograph 1104, on the roster 1102. For example, the Autograph 1004 on the e-ticket 1002 matches the Autographs 1104, on the flight roster 1102. If there are no matches, a problem is immediately detected and the ground crew can pull that passenger or traveler aside to resolve the issue without affecting the rest of the ground operation and the speed at which they proceed.

Operations for the above system and subsystem may be further described with reference to the following figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context. Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory module. For example, the memory module may include any memory device, memory article, memory medium, storage device, storage article, storage medium and/or storage module, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

While various embodiments have been shown and described, it should be understood that other modifications, substitutions and alternatives are apparent to one of ordinary skill in the art. Such modifications, substitutions, and alternatives can be made without departing from the scope of the embodiments, which should be determined from the appended claims.

What is claimed is:

1. A method, comprising:
displaying information identifying a product attribute associated with a purchased product on a client system, wherein the product attribute comprises features that are not included in the purchase of the product;
receiving a request from a user for the product attribute;
transmitting the request to a host system; and
assigning the product attribute based on the request relative to other requests for the product attribute until the product attribute is no longer available for assignment.

2. The method of claim 1, wherein the request includes any one of a bid price for the attribute, a single user preference request for the attribute, and a multi-user preference request for the attribute.

3. The method of claim 1, comprising assigning the product attribute to satisfy a maximum number of users that submit a number of requests for the product attribute.

4. The method of claim 3, comprising assigning the product attribute to satisfy the maximum number of users based on the request for the product attribute or the number of requests for the product attribute.

5. The method of claim 1, wherein the request for the product attribute is relative to a base price of the product and does not impact the base price of the product.

6. The method of claim 1, comprising assigning product attributes of limited availability over a predetermined time frame.

7. The method of claim 1, comprising:
assigning the current request for the product attribute if the current request can be satisfied based on all previous requests for the product attribute and the current request for the product attribute; and
denying the current request for the product attribute if the current request cannot be satisfied based on all previous requests for the product attribute.

8 The method of claim 7, comprising providing alternative product attributes to the user if the current request for the product attribute is denied.

9. The method of claim 1, comprising:
displaying a predetermined minimum number of product attributes to guarantee at least one choice to the user.

10. The method of claim 1, wherein the purchased product is a travel ticket, wherein the product attribute includes any one of a boarding preference and a seating preference associated with the purchased ticket, and wherein the boarding preference and the seating preference is not included in the purchased travel ticket, wherein the seating preference comprises any one of an aisle set, a window seat, a seat near a lavatory, a seat away from the lavatory, a seat away from minors, a front seat, a back seat near a ramp, a seat with power plugs for electronic devices, a seat with Internet access.

11. A method, comprising:
transmitting information identifying a product attribute associated with a purchased product to a client system, wherein the product attribute comprises features that are not included in the purchased product;
receiving a request from the client system for the product attribute; and
assigning the product attribute based on the request relative to other requests for the product attribute until the product attribute is no longer available for assignment.

12. The method of claim 11, comprising:
determining a minimum number of product attributes to guarantee at least one choice to the user.

13. The method of claim 12, comprising:
determining the minimum number of product attributes in accordance with an optimization process; and
transmitting to the client system the minimum number of product attributes.

14. The method of claim 11, wherein the request includes any one of a bid price for the attribute, a single user preference request for the attribute, and a multi-user preference request for the attribute.

15. The method of claim 11, comprising assigning the product attribute to satisfy a maximum number of users that submit a number of requests for the product attribute.

16. The method of claim 15, comprising assigning the product attribute to satisfy the maximum number of users based on the request for the product attribute or the number of requests for the product attribute.

17. The method of claim 11, wherein the request for the product attribute is relative to a base price of the product and does not impact the base price of the product.

18. The method of claim 11, comprising assigning product attributes of limited availability over a predetermined time frame.

19. The method of claim 11, comprising:
assigning the current request for the product attribute if the current request can be satisfied based on all previous requests for the product attribute and the current request for the product attribute; and
denying the current request for the product attribute if the current request cannot be satisfied based on all previous requests for the product attribute.

20. The method of claim 19, comprising transmitting to the client system alternative product attributes available to the user if the current request for the product attribute is denied.

21. The method of claim 11, comprising transmitting to the client system a predetermined minimum number of product attributes to guarantee at least one choice to the user.

22. The method of claim 11, wherein the purchased product is a travel ticket, wherein the product attribute includes any one of a boarding preference and a seating preference associated with the purchased ticket, and wherein the boarding preference and the seating preference is not included in the purchased travel ticket, wherein the seating preference comprises any one of an aisle set, a window seat, a seat near a lavatory, a seat away from the lavatory, a seat away from minors, a front seat, a back seat near a ramp, a seat with power plugs for electronic devices, a seat with Internet access.

23. A client system, comprising:
a user interface to display information identifying a product attribute associated with a purchased product, wherein the product attribute comprises features that are not included in the purchase of the product, the user interface to receive a request from a user for the product attribute and transmit the request to a host system, the user interface to receive an assignment of the product attribute based on the request relative to other requests for the product attribute until the product attribute is no longer available for assignment.

24. The client system of claim 23, wherein the request includes any one of a bid price for the attribute, a single user preference request for the attribute, and a multi-user preference request for the attribute.

25. The client system of claim 23, wherein the user interface is to display alternative product attributes to the user if the current request for the product attribute is denied.

26. The client system of claim 23, wherein the user interface is to display a predetermined minimum number of product attributes to guarantee at least one choice to the user.

27. The client system of claim 23, wherein the purchased product is a travel ticket, and wherein the user interface is to display a seat map and a legend that describes any one of available seats, seats requested by other users, popular seats, and assigned seats.

28. A host system, comprising:
a web server to transmit information identifying a product attribute associated with a purchased product to a client system, wherein the product attribute comprises features that are not included in the purchased product and to receive a request from the client system for the product attribute; and
an application server to assign the product attribute based on the request relative to other requests for the product attribute until the product attribute is no longer available for assignment.

29. The host system of claim 28, comprising an optimization engine to determine a minimum number of product attributes to guarantee at least one choice to the user.

30. The host system of claim 29, wherein the optimization engine is to determine the minimum number of product attributes in accordance with an optimization process; and to transmit to the client system the minimum number of product attributes.

31. The host system of claim 29, wherein the optimization engine is to assign the product attribute to satisfy a maximum number of users that submit a number of requests for the product attribute.

32. The host system of claim 31, wherein the optimization engine is to assign the product attribute to satisfy the maximum number of users based on the request for the product attribute or the number of requests for the product attribute.

33. The host system of claim 29, wherein the optimization engine is to assign product attributes of limited availability over a predetermined time frame.

34. The host system of claim 29, wherein the optimization engine is to assign the current request for the product attribute if the current request can be satisfied based on all previous requests for the product attribute and the current request for the product attribute; and to deny the current request for the product attribute if the current request cannot be satisfied based on all previous requests for the product attribute.

35. The host system of claim 34, wherein the optimization engine is to provide alternative product attributes to the user if the current request for the product attribute is denied.

36. The host system of claim 29, wherein the optimization engine comprises instructions that when executed by a processor determine a maximum flow from a source “s” to a sink “t” to determine an optimal assignment of product attributes according to user preferences.

37. The host system of claim 28, wherein the web server is to transmit to the client system a predetermined minimum number of product attributes to guarantee at least one choice to the user.

38. The host system of claim 29, wherein the optimization engine comprises instructions that when executed by a processor represent available preferences and requests placed by users in terms of a graph and reduce the graph to a mapping of each distinct preference with a distinct request using a pruning algorithm.
